(19) United States
(12) Patent Application Publication
(10) Pub. No.: US 2026/0158519 A1
(43) Pub. Date: Jun. 11, 2026

(54) SLOT DIE COATER AND SLOT DIE COATING METHOD USING THE SAME

(71) Applicant: SAMSUNG SDI CO., LTD., Yongin-Si (KR)

(72) Inventor: Sangjin KIM, Yongin-Si (KR)

(21) Appl. No.: 19/277,293

(22) Filed: Jul. 22, 2025

(30) Foreign Application Priority Data
Dec. 6, 2024 (KR) 10-2024-0180341

(51) Int. Cl. B05C 11/10; B05C 5/02

(52) U.S. Cl. CPC B05C 11/1007; B05C 5/0254

(57) ABSTRACT

A slot die coater including: a first die including an injection port to receive a supply of a slurry; a second die spaced from the first die; a spacer between the first die and the second die, the spacer having a hollow space connected to the injection port through a through hole in one surface of the spacer; and an ultrasonic generator at the spacer. The spacer includes: a body having the hollow space, and in which the ultrasonic generator is located; and a discharge port at an opening in one side of the body, and to discharge the slurry from the hollow space toward a substrate. The ultrasonic generator is to transmit ultrasonic waves to the slurry accommodated in the hollow space through the body.

### CROSS-REFERENCE TO RELATED APPLICATION

The present application claims priority to and the benefit of Korean Patent Application No. 10-2024-0180341, filed on Dec. 6, 2024, in the Korean Intellectual Property Office, the entire disclosure of which is incorporated by reference herein.

### BACKGROUND

### 1. Field

Aspects of embodiments of the present disclosure relate to a slot die coater, and a slot die coating method using the slot die coater.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries may be manufactured by inserting an electrode assembly including a positive electrode plate, a negative electrode plate, and a separator into a case, and then sealing the case accommodating the electrode assembly with a cap plate. The positive electrode plate may be manufactured by applying a slurry for a positive active material onto a substrate, and the negative electrode plate may be manufactured by applying a slurry for a negative active material onto a substrate.

Slot die coating technology may be used to uniformly apply an active material slurry to a substrate in a secondary battery manufacturing process. A slot die coater may precisely control the viscosity and the coating thickness of the slurry, so it may be used to stably produce high-quality electrodes. In a slot die coating process, the slurry applied through a spacer of the slot die may be evenly distributed over the substrate, and this uniform coating may directly affect the performance and lifespan of the battery.

The above information disclosed in this Background section is for enhancement of understanding of the background of the present disclosure, and therefore, it may contain information that does not constitute related (or prior) art.

### SUMMARY

In a slot die coating process, if foreign matter, such as lumps, are caught between the spacer and the substrate, the slurry may not be properly discharged, causing coating defects, such as stripes. In addition, if bubbles generated in the slurry are discharged and coated on the substrate, the bubbles may burst during subsequent processes, such as a drying process, causing bubble defects, such as spots.

Currently, there may be no sufficient way to remove or improve causes of such defects during coating, so a certain amount of the coated substrate including the defective portion may be discarded. Therefore, whenever a defective part of the coated substrate is subsequently worked on during a subsequent process, the work may be stopped so that the defective part may be discarded, and the work may be started again, which may result in a decrease in a workability and an increase in production and processing costs.

Embodiments of the present disclosure may be directed to an improved slot die coater, and a slot die coating method using the slot die coater.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a slot die coater includes: a first die including an injection port configured to receive a supply of a slurry; a second die spaced from the first die; a spacer between the first die and the second die, the spacer having a hollow space connected to the injection port through a through hole in one surface of the spacer; and an ultrasonic generator at the spacer. The spacer includes: a body having the hollow space, and in which the ultrasonic generator is located; and a discharge port at an opening in one side of the body, and configured to discharge the slurry from the hollow space toward a substrate. The ultrasonic generator is configured to transmit ultrasonic waves to the slurry accommodated in the hollow space through the body.

In an embodiment, the body may have an inner end facing the discharge port, the inner end having a slope to gradually become thicker toward the discharge port.

In an embodiment, the slot die coater may further include a controller connected to the ultrasonic generator, and configured to control an operation of the ultrasonic generator to regulate the ultrasonic waves transmitted to the slurry accommodated in the hollow space.

In an embodiment, the controller may be configured to control an operation of the ultrasonic generator according to an amount of bubbles generated in the slurry accommodated in the hollow space.

In an embodiment, the ultrasonic generator may be located inside the body to be adjacent to the discharge port, and may be configured to transmit the ultrasonic waves to the slurry being discharged through the discharge port.

In an embodiment, the slot die coater may further include a filter in the hollow space of the body, the filter configured to filter out foreign substances contained in the slurry.

In an embodiment, the body may include: a first body having at least one first filter groove; and a second body coupled to the first body, and having at least one second filter groove. The filter may include at least one mesh filter inserted into the first filter groove and the second filter groove.

In an embodiment, the first body and the second body may be detachably coupled to each other, and the filter may be configured to be detachable from the first filter groove and the second filter groove.

In an embodiment, the filter may include a segmented filter partitioned through a plurality of slits, the segmented filter being coupled to an inside of the body to be adjacent to the discharge port.

In an embodiment, a spacing between the slits may have a distance according to a size of a foreign substance from among the foreign substances contained in the slurry.

According to one or more embodiments of the present disclosure, a method of coating a slot die, includes: disposing a slot die coater adjacent to a substrate transported by a coating roll, the slot die coater including a first die, a second die, and a spacer having an ultrasonic generator installed therein; supplying a slurry to an injection port formed in the first die; operating the ultrasonic generator through a controller connected to the ultrasonic generator; and discharging the slurry from a hollow space formed in the spacer toward the substrate.

In an embodiment, the spacer may include: a body having the hollow space formed therein, and including the ultrasonic generator; and a discharge port formed by opening one side of the body, the discharge port to discharge the slurry from the hollow space toward the substrate. The operating of the ultrasonic generator may include transmitting, by the ultrasonic generator, ultrasonic waves to the slurry accommodated in the hollow space through the body.

In an embodiment, the body may have an inner end facing the discharge port, the inner end having a slope to gradually become thicker toward the discharge port.

In an embodiment, the operating of the ultrasonic generator may include regulating, by the controller, ultrasonic waves transmitted to the slurry accommodated in the hollow space.

In an embodiment, the operating of the ultrasonic generator may include controlling, by the controller, an operation of the ultrasonic generator according to an amount of bubbles generated in the slurry accommodated in the hollow space.

In an embodiment, the ultrasonic generator may be disposed inside the body to be adjacent to the discharge port, and may transmit ultrasonic waves to the slurry being discharged through the discharge port. The controller may operate the ultrasonic generator while discharging the slurry.

In an embodiment, the slot die coater may further include a filter disposed in the hollow space of the body, the filter filtering out foreign substances contained in the slurry.

In an embodiment, the body may include: a first body having at least one first filter groove; and a second body coupled to the first body, and having at least one second filter groove. The filter may include at least one mesh filter inserted into the first filter groove and the second filter groove.

In an embodiment, the first body and the second body may be detachably coupled to each other, and the filter may be detachable from the first filter groove and the second filter groove.

In an embodiment, the filter may include a segmented filter partitioned through a plurality of slits, the segmented filter being coupled to an inside of the body to be adjacent to the discharge port.

According to some embodiments of the present disclosure, bubbles that may be generated in a slurry may be removed or raised by an ultrasonic generator, so as to prevent or substantially prevent the bubbles from being discharged through a discharge port of a spacer. Accordingly, a bubble-free slurry may be discharged and applied onto a substrate, thereby preventing or substantially preventing coating defects that may be caused by bubbles.

According to some embodiments of the present disclosure, a dispersibility of the slurry may be improved by using an ultrasonic generator before (e.g., immediately before) discharging the slurry, thereby ensuring a uniform or substantially uniform coating quality.

According to some embodiments of the present disclosure, a filtering structure may be added to a hollow inner space of the spacer to filter out foreign substances in the slurry. This may prevent or substantially prevent foreign substances from being discharged through the discharge port of the spacer, and may prevent or substantially prevent coating defects, such as stripes, that may be caused by foreign substances getting caught between the spacer and the substrate.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view illustrating a slot die coater and a substrate according to some embodiments of the present disclosure.

FIG. 2 is an exploded perspective view illustrating a slot die coater and a substrate according to some embodiments of the present disclosure.

FIG. 3 is an exploded perspective view illustrating a slot die coater according to some embodiments of the present disclosure.

FIG. 4 is a perspective view of a spacer according to an embodiment of the present disclosure.

FIG. 5 is a bottom view of a spacer according to an embodiment of the present disclosure.

FIG. 6 is cross-sectional view taken along the line B-B′ of FIG. 4, and schematically illustrates a slurry being discharged toward a substrate from a spacer.

FIG. 7 is a cross-sectional view taken along the line A-A′ of FIG. 4, and schematically illustrates a spacer being disposed toward a substrate.

FIG. 8 is a cross-sectional view taken along the line A-A′ of FIG. 4, and schematically illustrates a slurry being discharged from a spacer and coated on a substrate.

FIG. 9 is a cross-sectional view taken along the line A-A′ of FIG. 4, and schematically illustrates a filter added to a spacer.

FIG. 10 is a cross-sectional view taken along the line B-B′ of FIG. 4, and schematically illustrates an example of a filter disposed in a spacer.

FIG. 11 is a perspective view schematically illustrating a first body in a spacer according to an embodiment of the present disclosure.

FIG. 12 is a schematic view illustrating foreign substances filtered out in a filter that is combined with the first body of FIG. 11.

FIG. 13 is a cross-sectional view taken along the line B-B′ of FIG. 4, and schematically illustrates a filter of a spacer combined with the filter of FIG. 9.

FIG. 14 is a drawing schematically illustrating a perspective view of a filter according to the example of FIG. 13.

FIG. 15 is a flowchart of a slot die coating method according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the drawings, the sizes and relative sizes of layers and regions may be exaggerated for convenience of illustration. In other words, the present disclosure is not limited to the sizes shown in the drawings. Additionally, the same reference numerals may refer to the same components throughout the specification.

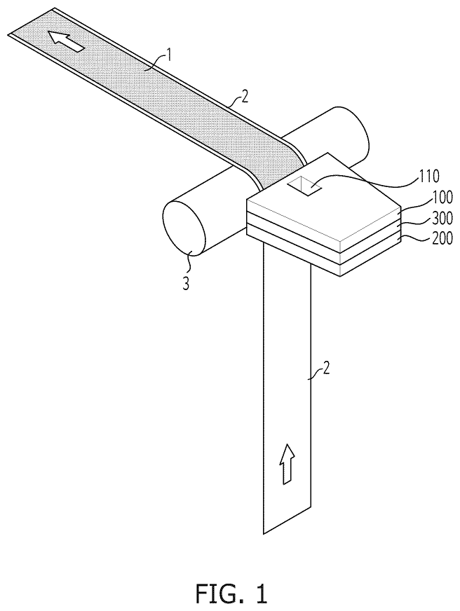

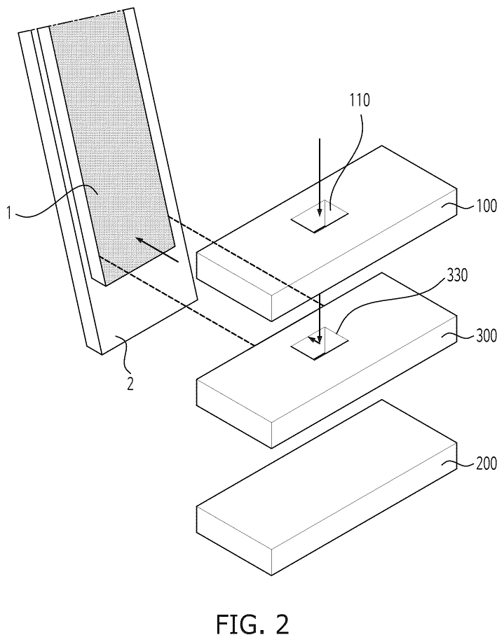

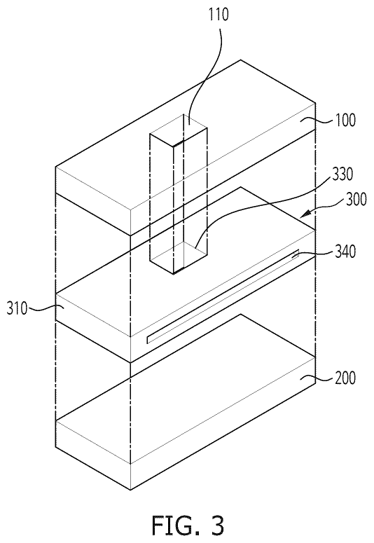

FIG. 1 is a perspective view illustrating a slot die coater and a substrate according to some embodiments of the present disclosure. FIG. 2 is an exploded perspective view illustrating a slot die coater and a substrate according to some embodiments of the present disclosure. FIG. 3 is an exploded perspective view illustrating a slot die coater according to some embodiments of the present disclosure.

Referring to FIGS. 1 to 3, a slot die coater may apply an electrode slurry 1 for a secondary battery to a substrate 2, and may include a first die 100, a second die 200, and a spacer 300. The first die 100 and the second die 200 may be spaced apart from each other to symmetrically face each other, and the spacer 300 may be positioned between the first die 100 and the second die 200 to space them apart from each other. The first die 100 and the second die 200 may be indirectly joined to each other using the spacer 300 as an intermediate medium.

The slot die coater according to some embodiments may be positioned to be close to one surface of the substrate 2 that may be wound and transported, so that a material discharged through a discharge port 340 may be directly coated or applied on the substrate 2 in a desired pattern (e.g., a specific or predetermined pattern). The substrate 2 may be a reel-kind metal thin film or a metal film.

In more detail, the substrate 2 may be an electrode substrate used in an electrode assembly of a secondary battery. For example, copper Cu may be used as a negative electrode substrate, and aluminum Al, nickel Ni, or stainless steel may be used as a positive electrode substrate. As another example, the substrate 2 may be a composite substrate including an insulator, and a metal layer formed on both surfaces (e.g., opposite surfaces) of the insulator. In some embodiments, the substrate 2 may be continuously transported by a rotation of a coating roll 3, and the slot die coater may continuously apply the slurry 1 to the transported substrate 2.

As an example, the first die 100 may be formed in an approximately hexahedral shape, and may have a flat or substantially flat upper surface and a flat or substantially flat lower surface. The upper and lower surfaces of the first die 100 may be formed in an approximately rectangular shape. The first die 100 may have an injection port 110 through which the slurry 1 is supplied. The injection port 110 may be a hole formed by penetrating the first die 100. For example, the injection port 110 may be formed through approximately the center of the first die 100. However, the location of the injection port 110 is not particularly limited thereto.

In some embodiments, the second die 200 may be disposed to be spaced apart from the first die 100. The second die 200 may be positioned to be spaced apart from and facing the first die 100. The second die 200 may be formed in a roughly hexahedral shape, and may have a flat or substantially flat upper surface and a flat or substantially flat lower surface. The upper and lower surfaces of the second die 200 may be formed in an approximately rectangular shape.

In some embodiments, the spacer 300 may be disposed between the first die 100 and the second die 200. The spacer 300 may be formed in a roughly hexahedral shape, and may have a flat or substantially flat upper surface and a flat or substantially flat lower surface. The upper and lower surfaces of the spacer 300 may be formed in an approximately rectangular shape.

The spacer 300 may have a through hole 330 in one surface thereof. For example, the through hole 330 may be formed in the upper surface of the spacer 300, and may be connected to the injection port 110. The spacer 300 may be formed of a suitable material having sealing properties to prevent or substantially prevent the slurry 1 from leaking into a gap between the first die 100 and the spacer 300.

Although configurations of the first die 100, the second die 200, and the spacer 300 are illustrated, the present disclosure is not limited thereto, and the first die 100, the second die 200, and the spacer 300 may be formed in various suitable forms.

The spacer 300 may have a hollow space connected to the injection port 110 through the through hole 330 formed in one surface of the spacer 300. The slurry 1 injected from the injection port 110 may move along the through hole 330, and may be accommodated in the hollow space. The hollow space formed in the spacer 300 may form a space in which the slurry 1 is accommodated. The through hole 330 may be formed in the upper surface of the spacer 300, so that the slurry 1 may be injected into the hollow space.

The spacer 300 may include a body 310 and the discharge port 340. The hollow space may be formed inside the body 310 to accommodate the slurry 1. The spacer 300 may include the discharge port 340 through which the slurry 1 is discharged from the hollow space toward the substrate 2. The discharge port 340 may be formed by opening one side of the body 310 to discharge the slurry 1 from the hollow space toward the substrate 2. The width at which the slurry 1 is discharged may correspond to the width of the discharge port 340.

In some embodiments, the coating roll 3 may be positioned in front of the discharge port 340, and may be spaced apart therefrom at a suitable distance (e.g., a predetermined distance). The coating roll 3 may be (e.g., may define) a movement path of an object to be coated, and the object may be, for example, the substrate 2. The slurry 1 sprayed from the discharge port 340 of the spacer 300 may be coated on the substrate 2 passing through the coating roll 3. In some embodiments, the spacer 300 may discharge the slurry 1 at a vertical or oblique angle with respect to the direction of the movement of the substrate 2. The arrow shown in FIG. 2 may indicate the direction of the movement of the slurry 1. In other words, the slurry 1 injected into the injection port 110 may be accommodated inside the spacer 300 through the through hole 330, and may be discharged through the discharge port 340.

The coating roll 3 may continuously or substantially continuously move the substrate 2 to be coated along a path. Accordingly, the slurry 1 discharged from the discharge port 340 may be coated on the surface of the substrate 2 that is continuously or substantially continuously moved by the coating roll 3. In this case, the coating width of the slurry 1 coated on the surface of the substrate 2 may be determined according to the length of the discharge port 340 according to some embodiments of the present disclosure.

The slurry 1 may be manufactured or formed by mixing a solvent, an active material, a conductive agent, and a binder with each other. For example, the slurry 1 may include a slurry for a positive electrode active material, or a slurry for a negative electrode active material. The slurry 1 may be used in a wet process or a dry process, but the present disclosure is not limited thereto.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The positive electrode active material may be used to manufacture or form a positive electrode for a lithium secondary battery. A positive electrode for a rechargeable lithium battery may include a current collector and a positive electrode active material layer on the current collector. The positive electrode active material layer may include a positive electrode active material and may further include a binder and/or a conductive material(e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity(e.g., electrical conductivity) to the electrode. Any material that does not cause chemical change(e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof. The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The negative electrode active material may be used to manufacture or form a negative electrode for a lithium secondary battery. The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity(e.g., electrical conductivity) to the electrode. Any material that does not cause chemical change(e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

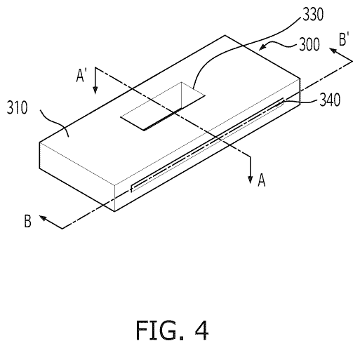

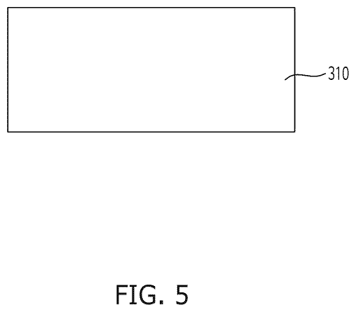

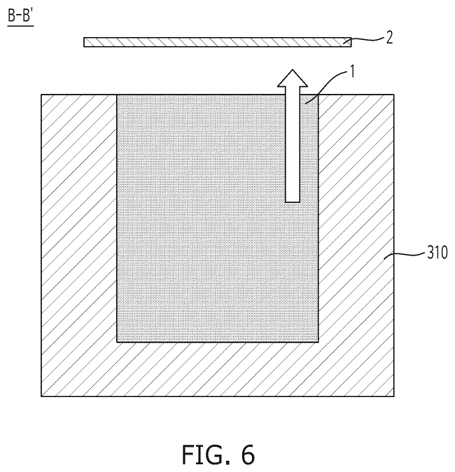

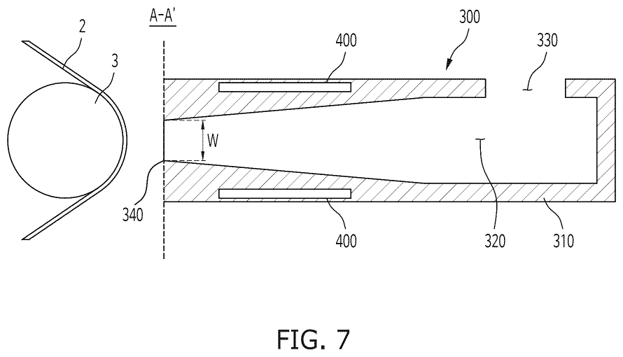

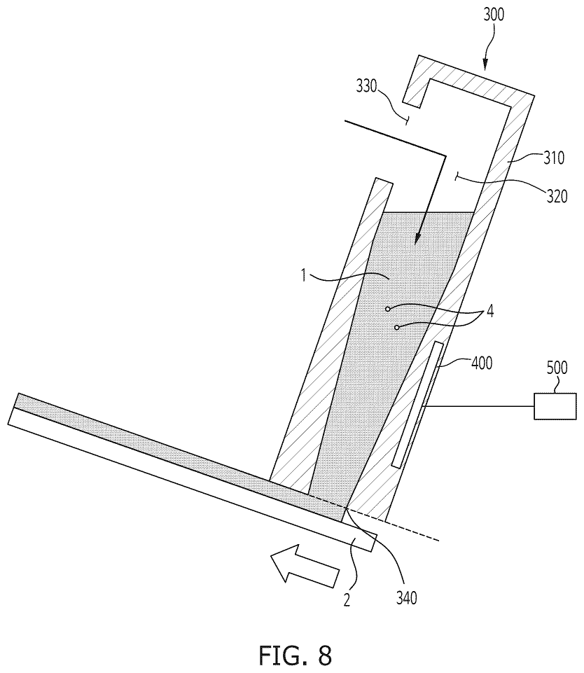

FIG. 4 is a perspective view of a spacer according to an embodiment of the present disclosure. FIG. 5 is a bottom view of a spacer according to an embodiment of the present disclosure. FIG. 6 is a cross-sectional view taken along the line B-B′ of FIG. 4, and schematically illustrates a slurry being discharged toward a substrate from a spacer. FIG. 7 is a cross-sectional view taken along the line A-A′ of FIG. 4, and schematically illustrates a spacer being disposed toward a substrate. FIG. 8 is a cross-sectional view taken along the line A-A′ of FIG. 4, and schematically illustrates a slurry being discharged from a spacer and coated on a substrate.

In some embodiments, the spacer 300 may have a hollow space 320 that receives a slurry 1, which flows in through a through hole 330. The through hole 330 may be formed in one surface of the body 310, so as to be connected to the hollow space 320 and allow the slurry 1 to flow. For example, the through hole 330 may be formed in the upper surface of the body 310 in FIG. 4. The lower surface of the body 310 may have a flat or substantially flat rectangular shape with no holes, as shown in FIG. 5. Therefore, the slurry 1, which flows in through the through hole 330, may be accommodated in the hollow space 320.

An ultrasonic generator 400 may be installed at (e.g., in or on) the spacer 300. The ultrasonic generator 400 may be installed in the body 310. The ultrasonic generator 400 may transmit ultrasonic waves to the slurry 1 accommodated in the hollow space 320 through the body 310. In some embodiments, the ultrasonic generator 400 may be installed inside the body 310. For example, a pair of ultrasonic generators 400 may be installed on both sides (e.g., opposite sides) of the hollow space 320, or one ultrasonic generator 400 may be installed on one side of the hollow space 320.

An electrode for a secondary battery may be manufactured using the slurry 1, but if bubbles 4 are mixed into the slurry 1, a defect in the electrode may be caused. In other words, a method for manufacturing the electrode slurry may include manufacturing or forming a mixture by mixing raw materials inside a mixer, and the bubbles 4 may exist inside the mixture, which may be a suspension having a fluidity and a viscosity.

The bubbles 4 may represent gas existing inside the slurry 1. For example, the bubbles 4 may be or include various substances, such as oxygen, carbon dioxide, and/or the like. Secondary batteries manufactured using these defective electrodes may have lithium salts generated inside, which may lower a safety and a reliability thereof.

According to some embodiments of the present disclosure, an electrode failure due to the bubbles 4 may be prevented or substantially prevented through the ultrasonic generator 400. For example, the ultrasonic generator 400 may transmit ultrasonic waves to the slurry 1 to remove the air bubbles 4 inside the slurry 1. Removing the bubbles 4 may mean that the bubbles 4 burst and/or are removed from inside the slurry 1.

Additionally, the ultrasonic generator 400 may transmit ultrasonic waves to the slurry 1 to cause the bubbles 4 inside the slurry 1 to rise. In other words, the ultrasonic generator 400 may raise the bubbles 4, so that the bubbles 4 do not head toward the discharge port 340. As such, the slurry 1 without the bubbles 4 may be discharged through the discharge port 340 and applied on the substrate 2, and a poor coating of the electrode due to the bubbles 4 may be prevented or substantially prevented.

In some embodiments, the slot die coater may further include a control unit (e.g., a controller) 500 connected to the ultrasonic generator 400. The control unit 500 may control the operation of the ultrasonic generator 400 to adjust the ultrasonic waves transmitted to the slurry 1 accommodated in the hollow space 320. For example, the control unit 500 may control the operation of the ultrasonic generator 400 according to the amount of bubbles 4 generated in the slurry 1 accommodated in the hollow space 320.

The control unit 500 may control the overall operations of the ultrasonic generator 400, including the on/off operation of the ultrasonic generator 400, as well as the intensity of the ultrasonic waves generation. For example, the control unit 500 may include (e.g., may be) a computer, a central processing unit (CPU), and/or the like.

For example, the control unit 500 may start the operation of the ultrasonic generator 400 when the slurry 1 accommodated in the hollow space 320 contains bubbles 4. Additionally, the control unit 500 may control the ultrasonic generator 400 to raise the bubbles 4 when the bubbles 4 that are not removed move toward the discharge port 340. However, the control unit 500 may control the on/off operation of the ultrasonic generator 400 periodically, without going through a process of checking whether or not the bubbles 4 are generated, and the present disclosure is not limited thereto.

Additionally, according to some embodiments, the ultrasonic generator 400 may transmit ultrasonic waves to the slurry 1 to improve a dispersibility of the slurry 1. As time passes, the viscosity of the slurry 1 may increase, and the dispersibility may decrease, which may cause, for example, the formation of lumps.

The ultrasonic generator 400 may be disposed adjacent to the internal discharge port 340 of the body 310 to prevent or substantially prevent the increase in the viscosity of the slurry 1. Therefore, the ultrasonic generator 400 may transmit ultrasonic waves to the slurry 1 discharged through the discharge port 340. In this case, the dispersibility of the slurry may be improved by using the ultrasonic generator 400 just before the slurry 1 is discharged through the discharge port 340, thereby ensuring a uniform or substantially uniform coating quality.

In some embodiments, the body 310 may have an inner end facing the discharge port 340, and may be formed to become thicker toward the discharge port 340. For example, an inclination of the inner end of the body 310 toward the discharge port 340 may correspond to the amount of slurry 1 to be applied.

As the inclination of the inner end of the body 310 facing the discharge port 340 increases, a width w of the discharge port 340 decreases, and the amount of the slurry 1 discharged through the discharge port 340 may be decreased. On the other hand, as the inclination of the inner end of the body 310 facing the discharge port 340 decreases, the width w of the discharge port 340 increases, and the amount of the slurry 1 discharged through the discharge port 340 may be increased. In other words, the inclination of the inner end of the body 310 facing the discharge port 340 may be variously modified according to a desired thickness of the slurry 1 to be applied to the substrate 2.

In some embodiments, the interior of the body 310 may include a roughly wedge-shaped cross-section having a thickness that gradually decreases toward the discharge port 340. However, the internal cross-sectional shape of the body 310 is not limited thereto, and may have various suitable shapes that facilitate the applying of the slurry 1 to the substrate 2. Additionally, the inclination of the inner end of the body 310 may have various suitable inclinations.

The slurry 1 sprayed from the discharge port 340 may be coated on the substrate 2 passing through the coating roll 3. For example, the slurry 1 discharged from the discharge port 340 may be coated on the surface of the substrate 2 that is continuously or substantially continuously processed by the coating roll 3. The coated substrate 2 may move in the direction of the arrow in FIG. 8.

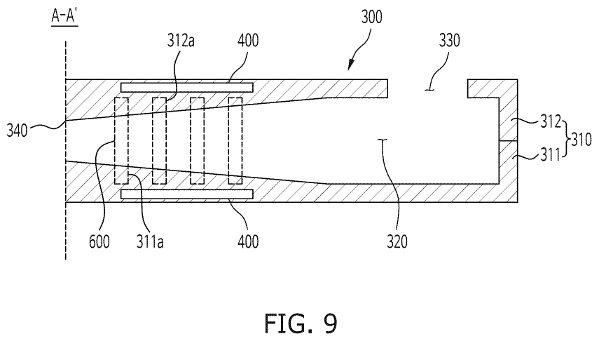

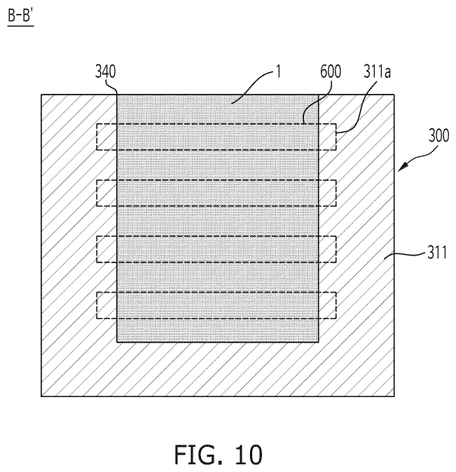

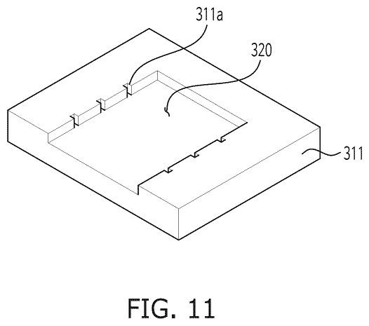

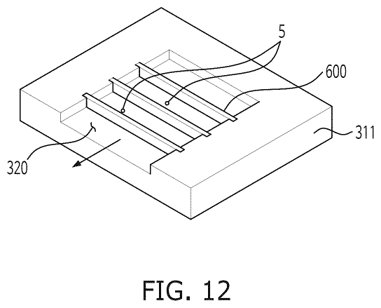

FIG. 9 is a cross-sectional view taken along the line A-A′ of FIG. 4, and schematically illustrates a filter added to a spacer. FIG. 10 is a cross-section view taken along the line B-B′ in FIG. 4, and schematically illustrates an example of a filter disposed in a spacer. FIG. 11 is a perspective view schematically illustrating a first body in a spacer according to an embodiment of the present disclosure. FIG. 12 is a schematic view illustrating foreign substances filtered out in a filter that is combined with the first body of FIG. 11.

Referring to FIGS. 9 to 12, the slot die coater may further include a filter 600, which may be disposed in the hollow space 320 of the body 310 to filter out foreign substances 5 that may be included in the slurry 1. In this case, the body 310 may be formed by combining a first body 311 with a second body 312.

In some embodiments, the first body 311 may include at least one first filter groove 311a. The second body 312 may be coupled to the first body 311, and may include at least one second filter groove 312a. The filter 600 may include at least one mesh filter that is inserted into the first filter groove 311a and the second filter groove 312a. For example, the mesh filter may be formed with a mesh size capable of filtering out foreign substances 5 (e.g., foreign substance particles) contained in the slurry 1.

According to some embodiments of the present disclosure, the foreign substances 5 contained in the slurry 1 accommodated in the hollow space 320 before being discharged through the discharge port 340 may be filtered out, thereby preventing or substantially preventing electrode coating defects, such as stripes, which may be caused by the foreign substances 5 being caught between the spacer 300 and the substrate.

The filter 600 filters out the foreign substances 5 in the slurry 1 before coating the substrate. If the size of particles of the foreign substances 5 in the slurry 1 are greater than the mesh size of the filter 600, the filter 600 may be blocked. If the particles of the foreign substances 5 continue to block the filter 600, the filter 600 may be clogged. Accordingly, the filter 600 according to some embodiments of the present disclosure may be replaceable as needed or desired.

In some embodiments, the first body 311 and the second body 312 may be detachably coupled to each other. The filter 600 may be detached from the first filter groove 311a and the second filter groove 312a. Therefore, when the filter 600 is excessively clogged with the foreign substances 5, the first body 311 may be separated from the second body 312, the existing filter 600 may be removed, and a new filter 600 may be placed.

In some embodiments, the number of filters 600 is not particularly limited, and the material of the filter 600 is also not particularly limited. For example, a plurality of filters 600 may be formed and disposed at a suitable gap (e.g., a predetermined gap) therebetween along the direction toward the discharge port 340. The mesh size of the filter 600 may be smaller as it becomes closer to the discharge port 340 to gradually filter out smaller foreign substances 5.

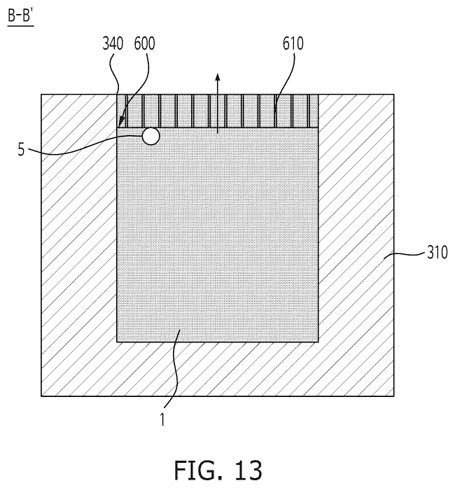

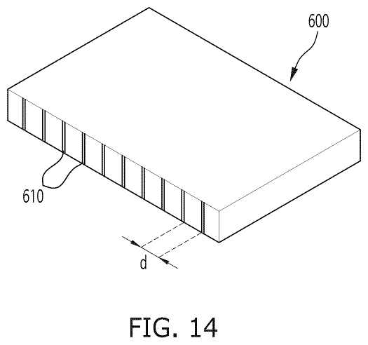

FIG. 13 is a cross-sectional view taken along the line B-B′ of FIG. 4, and schematically illustrates a filter of a spacer combined with the filter of FIG. 9. FIG. 14 is a drawing schematically illustrating a perspective view of a filter according to the example of FIG. 13.

Referring to FIGS. 13 and 14, the filter 600 may be a segmented filter 600 partitioned through a plurality of slits 610. In some embodiments, the filter 600 may be coupled to the interior of the body 310 adjacent to the discharge port 340. A spacing d of the slit 610 may correspond to a size of the foreign substances 5 included in the slurry 1.

In more detail, the spacing d of the slits 610 may be determined to be smaller than a size (e.g., a predetermined size) of the foreign substances 5 included in the slurry 1. Accordingly, the foreign substances 5 contained in the slurry 1 accommodated inside the body 310 may be filtered through the filter 600. In this case, the foreign substances 5 discharged through the discharge port 340 may be prevented or substantially prevented, and coating defects, such as stripes that may be caused by the foreign substances 5 getting caught between the spacer and the substrate may be prevented or substantially prevented.

In FIG. 13, the filter 600 is illustrated as being arranged as a segmented filter only, but the present disclosure is not limited thereto, and the arrangement of the filter 600 may be arranged by combining the mesh filter of FIGS. 9 to 12 with the segmented filter.

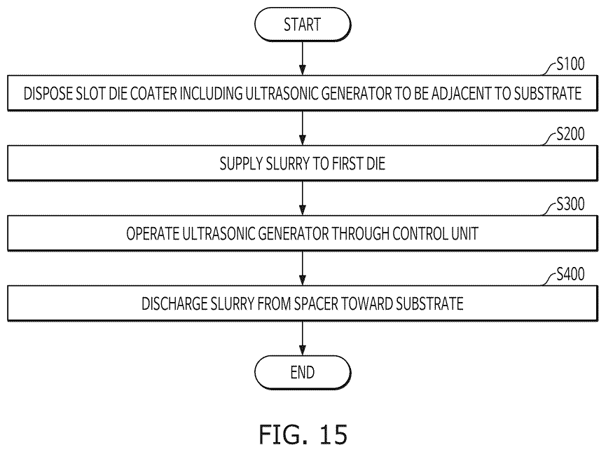

FIG. 15 is a flowchart of a slot die coating method according to some embodiments of the present disclosure.

In some embodiments, the slot die coating method may be performed by the slot die coater described above with reference to FIG. 1. Referring to FIG. 15, the slot die coating method may start when a slot die coater is placed to be adjacent to a substrate.

In more detail, referring to FIG. 15, the slot die coating method start, and a slot die coater including an ultrasonic generator may be disposed (e.g., may be arranged) to be adjacent to a substrate (S100). A slurry may be supplied to a first die (S200), and the ultrasonic generator may operate through a control unit (e.g., a controller) (S300). The slurry may be discharged from a spacer toward the substrate (S400), and the method may end.

In S100 of disposing the slot die coater to be adjacent to the substrate, the slot die coater may include a first die, a second die, and a spacer having the ultrasonic generator installed therein. In S100 of disposing the slot die coater to be adjacent to the substrate, the slot die coater may be disposed to be adjacent to the substrate that is transported by a coating roll.

In the supplying of the slurry to the first die (S200), the slurry may be supplied to an injection port formed in the first die. After the supplying of the slurry to the first die (S200), the hollow space of the spacer may accommodate the slurry.

In S300 of operating the ultrasonic generator through the control unit, the ultrasonic generator may be operated through the control unit connected to the ultrasonic generator. In some embodiments, the spacer may include a body having a hollow space formed therein, the ultrasonic generator may be installed therein, in which one side of the body is opened, and a discharge port for discharging the slurry from the hollow space toward the substrate. In the operating of the ultrasonic generator (S300), the ultrasonic generator may transmit ultrasonic waves to the slurry accommodated in the hollow space through the body of the spacer.

In the operating of the ultrasonic generator (S300), the control unit may control the ultrasonic waves transmitted to the slurry accommodated in the hollow space. For example, in S300 of operating the ultrasonic generator, the control unit may control the operation of the ultrasonic generator according to the amount of bubbles generated in the slurry accommodated in the hollow space.

After the operating of the ultrasonic generator (S300), the discharging of the slurry from the spacer toward the substrate (S400) may be performed. In other embodiments, the operating of the ultrasonic generator (S300) and the discharging of the slurry from the spacer toward the substrate (S400) may be performed concurrently (e.g., simultaneously or substantially simultaneously) with each other.

The S400 of the discharging of the slurry from the spacer toward the substrate may be an operation of discharging the slurry from the hollow space formed in the spacer toward the substrate. In this case, the body may have an inner end facing the discharge port, the inner end having a slope, and may be formed to become thicker toward the discharge port. In the discharging of the slurry (S400), the inclination of the inner end of the body toward the discharge port may correspond to the amount of the slurry to be discharged.

In the discharging of the slurry (S400), the ultrasonic generator may be disposed to be adjacent to the discharge port inside the body, so as to transmit the ultrasonic waves to the slurry discharged through the discharge port. The control unit may operate the ultrasonic generator in the discharging of the slurry (S400).

The slurry discharged in S400 may be a slurry with foreign substances filtered out. In this case, the slot die coater may further include a filter disposed in the hollow space of the body that filters out the foreign substances contained in the slurry. In some embodiments, the body may include a first body including at least one first filter groove, and a second body coupled to the first body and including at least one second filter groove. The filter may include at least one mesh filter inserted into the first filter groove and the second filter groove. In other embodiments, the filter may be a segmented filter partitioned by a plurality of slits, and the filter may be coupled to the interior of the body adjacent to the discharge port.

After the discharging of the slurry (S400), if foreign substances block the filter, the method may further include an operation of replacing the filter. In this case, the first body and the second body may be detachably coupled to each other, and the filter may be detached from the first filter groove and the second filter groove. The replacing of the filter may be performed by separating the first body from the second body, removing the existing filter, and then placing a new filter, if the filter becomes excessively clogged with foreign substances.

However, the present disclosure is not limited to the method of FIG. 15 described above, and the method may be various modified as needed or desired. For example, one or more operations in the flowchart of FIG. 15 described above may be added/changed/deleted, the order of one or more operations may be changed, and/or one or more operations may be performed concurrently (e.g., simultaneously or substantially simultaneously) with each other.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A slot die coater comprising:
a first die comprising an injection port configured to receive a supply of a slurry;
a second die spaced from the first die;
a spacer between the first die and the second die, the spacer having a hollow space connected to the injection port through a through hole in one surface of the spacer; and
an ultrasonic generator at the spacer,
wherein the spacer comprises:
a body having the hollow space, and in which the ultrasonic generator is located; and
a discharge port at an opening in one side of the body, and configured to discharge the slurry from the hollow space toward a substrate, and
wherein the ultrasonic generator is configured to transmit ultrasonic waves to the slurry accommodated in the hollow space through the body.

2. The slot die coater as claimed in claim 1, wherein the body has an inner end facing the discharge port, the inner end having a slope to gradually become thicker toward the discharge port.

3. The slot die coater as claimed in claim 1, further comprising a controller connected to the ultrasonic generator, and configured to control an operation of the ultrasonic generator to regulate the ultrasonic waves transmitted to the slurry accommodated in the hollow space.

4. The slot die coater as claimed in claim 3, wherein the controller is configured to control an operation of the ultrasonic generator according to an amount of bubbles generated in the slurry accommodated in the hollow space.

5. The slot die coater as claimed in claim 1, wherein the ultrasonic generator is located inside the body to be adjacent to the discharge port, and is configured to transmit the ultrasonic waves to the slurry being discharged through the discharge port.

6. The slot die coater as claimed in claim 1, further comprising a filter in the hollow space of the body, the filter configured to filter out foreign substances contained in the slurry.

7. The slot die coater as claimed in claim 6, wherein the body comprises:
a first body having at least one first filter groove; and
a second body coupled to the first body, and having at least one second filter groove, and
wherein the filter comprises at least one mesh filter inserted into the first filter groove and the second filter groove.

8. The slot die coater as claimed in claim 7, wherein the first body and the second body are detachably coupled to each other, and the filter is configured to be detachable from the first filter groove and the second filter groove.

9. The slot die coater as claimed in claim 6, wherein the filter comprises a segmented filter partitioned through a plurality of slits, the segmented filter being coupled to an inside of the body to be adjacent to the discharge port.

10. The slot die coater as claimed in claim 9, wherein a spacing between the slits has a distance according to a size of a foreign substance from among the foreign substances contained in the slurry.

11. A method of coating a slot die, the method comprising:
disposing a slot die coater adjacent to a substrate transported by a coating roll, the slot die coater comprising a first die, a second die, and a spacer having an ultrasonic generator installed therein;
supplying a slurry to an injection port formed in the first die;
operating the ultrasonic generator through a controller connected to the ultrasonic generator; and
discharging the slurry from a hollow space formed in the spacer toward the substrate.

12. The method as claimed in claim 11, wherein the spacer comprises:
a body having the hollow space formed therein, and comprising the ultrasonic generator; and
a discharge port formed by opening one side of the body, the discharge port to discharge the slurry from the hollow space toward the substrate, and
wherein, the operating of the ultrasonic generator comprises transmitting, by the ultrasonic generator, ultrasonic waves to the slurry accommodated in the hollow space through the body.

13. The method as claimed in claim 12, wherein the body has an inner end facing the discharge port, the inner end having a slope to gradually become thicker toward the discharge port.

14. The method as claimed in claim 11, wherein the operating of the ultrasonic generator comprises regulating, by the controller, ultrasonic waves transmitted to the slurry accommodated in the hollow space.

15. The method as claimed in claim 11, wherein the operating of the ultrasonic generator comprises controlling, by the controller, an operation of the ultrasonic generator according to an amount of bubbles generated in the slurry accommodated in the hollow space.

16. The method as claimed in claim 12, wherein the ultrasonic generator is disposed inside the body to be adjacent to the discharge port, and transmits ultrasonic waves to the slurry being discharged through the discharge port, and
wherein the controller operates the ultrasonic generator while discharging the slurry.

17. The method as claimed in claim 12, wherein the slot die coater further comprises a filter disposed in the hollow space of the body, the filter filtering out foreign substances contained in the slurry.

18. The method as claimed in claim 17, wherein the body comprises:
a first body having at least one first filter groove; and
a second body coupled to the first body, and having at least one second filter groove, and
wherein the filter comprises at least one mesh filter inserted into the first filter groove and the second filter groove.

19. The method as claimed in claim 18, wherein the first body and the second body are detachably coupled to each other, and the filter is detachable from the first filter groove and the second filter groove.

20. The method as claimed in claim 17, wherein the filter comprises a segmented filter partitioned through a plurality of slits, the segmented filter being coupled to an inside of the body to be adjacent to the discharge port.
